(19) United States
(12) Patent Application Publication
(10) Pub. No.: US 2005/0111704 A1
(43) Pub. Date: May 26, 2005

(54) Iris mapping and compatibility and personality evaluation

(76) Inventor: James Simon Verghis, Mancos, CO (US)

Correspondence Address: LAW OFFICE OF DAVID MCEWING, P.O. BOX 231324, HOUSTON, TX, 77023, US

(21) Appl. No.: 10/995,009

(22) Filed: Nov. 21, 2004

Related U.S. Application Data
(60) Provisional application No. 60/524,346, filed on Nov. 24, 2003.
(60) Provisional application No. 60/590,219, filed on Jul. 22, 2004.

(51) Int. Cl. G06K 9/00

(52) U.S. Cl. 382/117

(57) ABSTRACT

The present invention teaches observing and charting the iris structure of an individual participant. The data can then be evaluated using one or more algorithms. The object of the evaluation can include an assessment of the individual compatibility and personal attraction to others, including others whom also have been similarly evaluated. The evaluation can be compared with the evaluations of other individuals. The invention can be practiced in conjunction with other bio-markers. The invention includes recording the observed and charted information. A database of information can be created of the individual, including information relating to the iris as well as medical/health information, family history and socioeconomic information. A database of numerous individuals can be created. The accuracy of the evaluation can be assessed by other data collection and the evaluative factors modified accordingly. The invention may facilitate selection of couples for meaningful long-term relationships.

### RELATED APPLICATION

This application claims priority to U.S. Provisional Application 60/524,346 filed Nov. 21, 2003, and U.S. Provisional Application No. 60/590,219 entitled Behavioral Iridology and filed Jul. 22, 2004.

### BACKGROUND OF INVENTION

1. Field of Use

The present invention pertains to a method for using the uniquely individualized color and structure of the iris of the eye (“iris markers”) to make predictive evaluations of individual preferences and behavioral characteristics, particularly inter-personal relationship compatibility and romantic attraction.

2. Related Art

The pattern formed by the structure within the iris is generally accepted as unique to each individual and has been termed an “optical finger print”. Technologies have already been created that utilize this fact for instant recognition or identification of individuals. See for example U.S. Pat. No. 5,291,560 issued to John Daugman and entitled Biometric Personal Identification System Based on Iris Analysis.

Further, there is also acceptance that genetics play a significant role in the determination of the structures and shapes within the iris (“iris markers”). This certainly is accepted in regard to eye color. However, eye color is only one of the readily observable characteristics of the iris. Other factors are the structure of the fibers and pigmentation within the iris, including minor imperfections. Various efforts have been attempted to match the observable iris markers to physical health, or more recently to behavioral and personality types. Examples include “Iridology, The Science and Practice in the Healing Arts”, Volumes 1 & 2 by Bernard Jensen, copyrighted by Bernard Jensen International, 1982, and “Rayid Model Guide to Relationships by Denny Johnson and Douglas Thompson, copyrighted by Rayid Publications 1998. These efforts comprise part of the study of Iridology.

Methods for grouping or matching the compatibility of individuals, whether for romance, employment, or otherwise, has long been appreciated to have value. Various questionnaires and photo images have used to assist in the matching of compatible individuals. See for example U.S. Pat. No. 6,735,568 issued to J. Galen Buckwalter et al. and entitled Method and System for Identifying People Who are Likely to Have a Successful Relationship.

### SUMMARY OF INVENTION

The present invention observes and evaluates the iris of one or both eyes of an individual relative to the physical structure(s) and the shape of the structures (“iris markers” or “markers”). The invention teaches a method of evaluating the markers to evaluate personality and behavior. The invention also teaches a method of using evaluations to assess or predict behavior, particularly to inter-personal behavior and relationship attraction among a plurality of individuals.

The invention may be performed through a one-on-one interview with a trained examiner. The invention may also be performed by an examiner utilizing one or more algorithms or by a computer having software to process images of the eye, recognize color, structure, the relative shapes of the structures, map the location of the various detected structures and shapes, and to process the information in relation to such algorithms. The software or trained examiner can then provide an evaluation of the individual based upon the identified markers in the iris. The information or evaluation can be compared with information or evaluations of other individuals.

The invention can be utilized in combination with other individual physical characteristic such as the half moons in the thumbs, the individual's height and weight, shoulder width, diameter of one or both wrists or ankles, eyelid droop, birth order sequence or “yin or yang” body type (all such characteristics termed “bio-markers”).

The invention includes mapping the iris markers and recording the observed information. A database of information (“information” or “data collection”) can be created of the individual, including information relating to the iris as well as medical/health information, relationship preferences, family history and socioeconomic information. A database of numerous individuals can be created. The data collection(s) can be correlated to specific individuals or to other factors, e.g., gender, interpersonal relationship including but not limited to marriage. The information can be evaluated by a person or machine using, at least in part, commercially available optical sensors and computer software. Evaluative factors can be assigned to the individual specific information. The product of the evaluation can have use as a predictor of preferences and characteristics. The accuracy of the evaluation can be assessed by other data collection and the evaluative factors modified accordingly.

The invention includes utilizing digital technology combined with computer processing, to provide accurate, objective, uniform and rapid data collection and analysis. This can be then used for compatibility matching, as well as for behavior and preference predication.

The invention also includes using the collected information as a tool for studying the interrelationships between an individual's unique DNA, the established uniqueness of each individual's iris pattern (“markers”) and the individual's behavior and personality (as may be measured by any number of competing or complimentary behavior assessment tools, e.g. Myers Briggs, etc.)

The invention also includes the evaluation of the data of multiple individuals, resulting in a product of compatibility, incompatibility or subsets thereof. Further the evaluations or recorded data can be stored and compared with independent histories and testing to validate or refine the predictive accuracy of the examiner(s), algorithms or iris markers in analysis or prediction of behavior. These and other novel features and advantages of the present invention will be apparent from the following description of the embodiments with reference to the accompanying drawings. Other benefits of the invention will also become apparent to those skilled in the art and such advantages and benefits are included within the scope of this invention.

### SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIGS. 1A, 1B and 1C illustrate iris charts known in the prior art.

FIGS. 2, 2A and 2B illustrate an example of the “dotted pigmentation” structure category used in one embodiment of the invention.

FIGS. 3, 3A and 3B illustrates an example of the “rounded opening” structure category used in one embodiment of the invention.

FIG. 4 illustrates an examples of the “Neurogenic” structure category used in one embodiment of the invention combined with dotted pigment and rounded opening structures.

FIGS. 5 and 5A illustrate an iris containing a “combination” dotted pigmentation and rounded opening.

FIGS. 6A and 6B illustrate examples of the “Lymphatic Ring” secondary markers.

FIGS. 7A and 7B illustrate examples of the “Sodium Ring secondary markers.

FIGS. 8A and 8B illustrate examples of the “Nerve Ring” secondary markers.

FIGS. 9A and 9B illustrate examples of the “Scurf Ring” secondary markers.

FIG. 10 illustrates an example of the thumb nail half moon “bio marker” that may be used in an embodiment of the invention.

FIG. 11 illustrates a simple quadrant map of an eye that can be utilized to record the size and position of iris markers.

FIG. 12 illustrates a simple polar coordinate map of an eye that can be utilized to record the size and position of iris markers.

FIGS. 13A and 13B illustrates a business method flow chart that may be used in the practice of one embodiment of the invention for matching compatible individuals.

FIG. 14 illustrates another embodiment of a business method for matching compatible individuals.

### DETAILED DESCRIPTION OF INVENTION

The above general description and the following detailed description, which incorporates the Summary of Invention and Summary of Drawings by reference, are merely illustrative of the subject invention and additional modes, advantages and particulars of this invention will be readily suggested to those skilled in the art without departing from the spirit and scope of the invention.

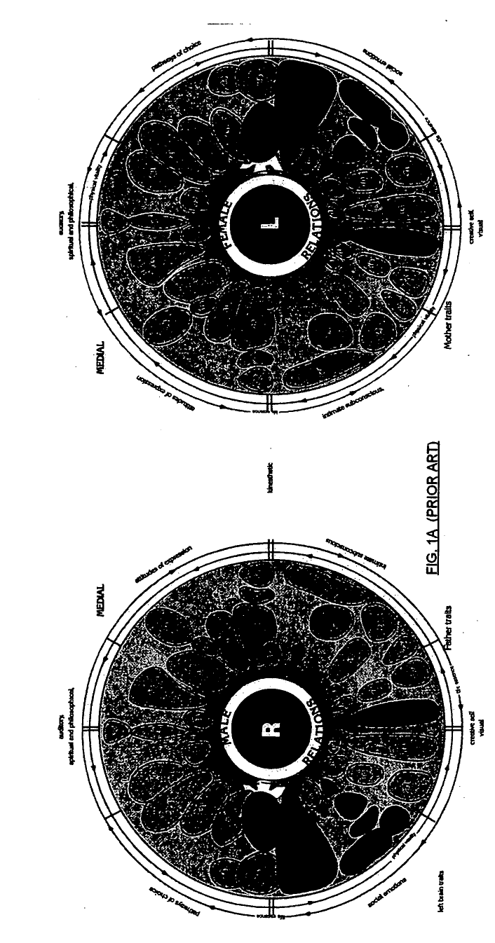

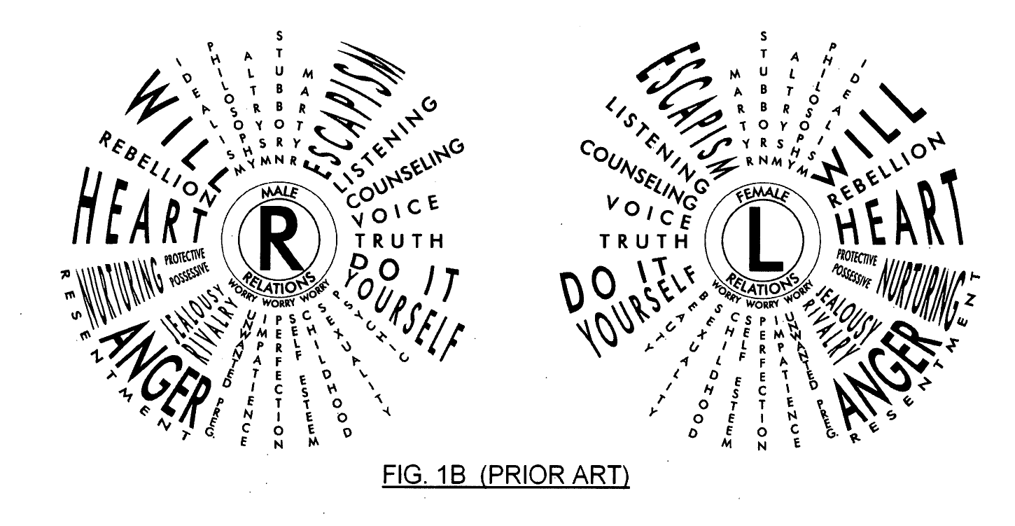

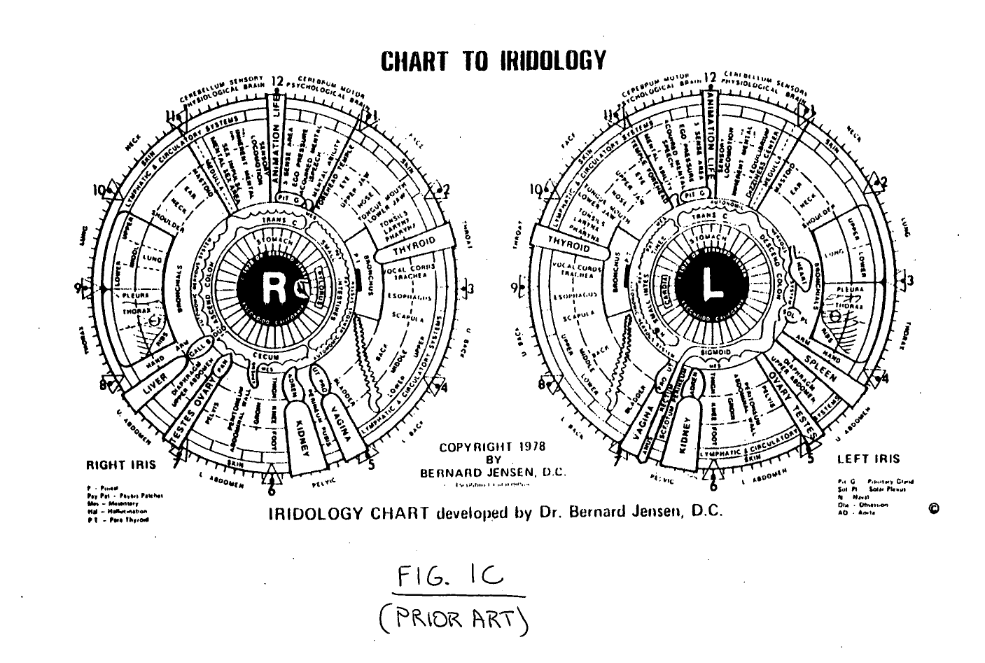

Methodologies or algorithms have been developed for detecting, mapping and recording iris markers. These include the various charts used in the study of Iridology. Examples are shown in FIGS. 1A, 1B and 1C. The algorithms and methods also include the patented technology used in identity recognition. Equipment and services, including digital cameras and computer software are commercially available for recording the iris structures or markers. For example, see “eyePIX6000 Digital Iriscope” of Iris Supplies PTY Ltd., and “IDC-2FS1 Digital Iris Camera” of Miles Research www.milesresearch.com.

The present invention teaches a method of utilizing iris markers to evaluate the personality or behavioral characteristics (collectively termed herein as “behavior”). The invention also teaches using evaluations to assess or predict likely compatibility or personal inter attraction between or among individuals. These evaluations utilize the information obtained regarding the iris markers, including category, size and location or position. The evaluation can be utilized with other information in making an assessment or prediction. The evaluation can also be used for purposes of determining suitability of an individual's personality for certain tasks or environments. In particular, the invention can be used to select an individual from a group.

The invention teaches a fast and efficient method for accurately categorizing and mapping iris markers and creating evaluations using objective, uniform and modifiable criteria. The invention teaches creation of a set of information or database (data collection) containing the categorization of iris markers and/or the evaluations of a plurality of individuals. The invention also teaches the creation of such information that is machine-readable. It will be appreciated that such information can be sorted, etc. as common with data processing technology.

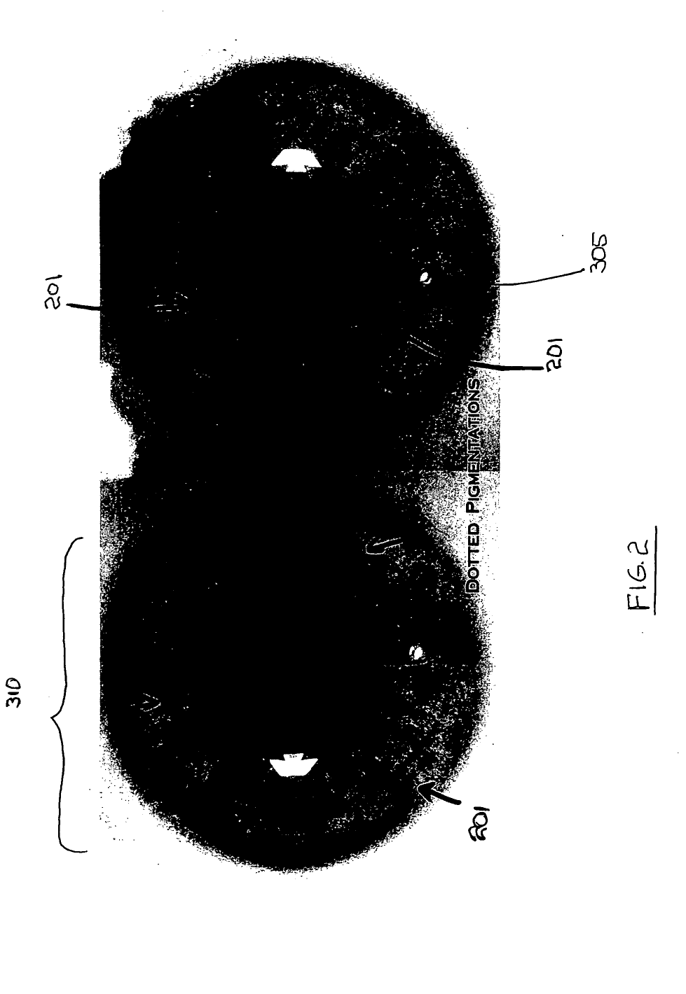

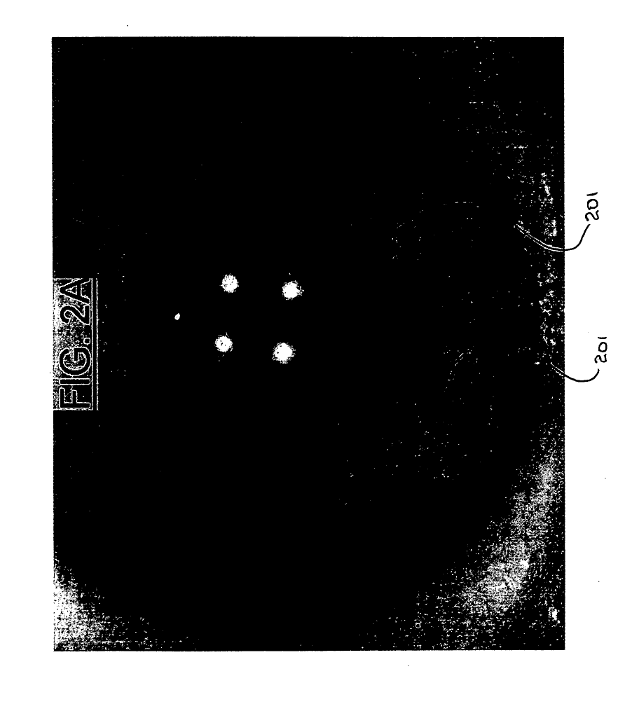

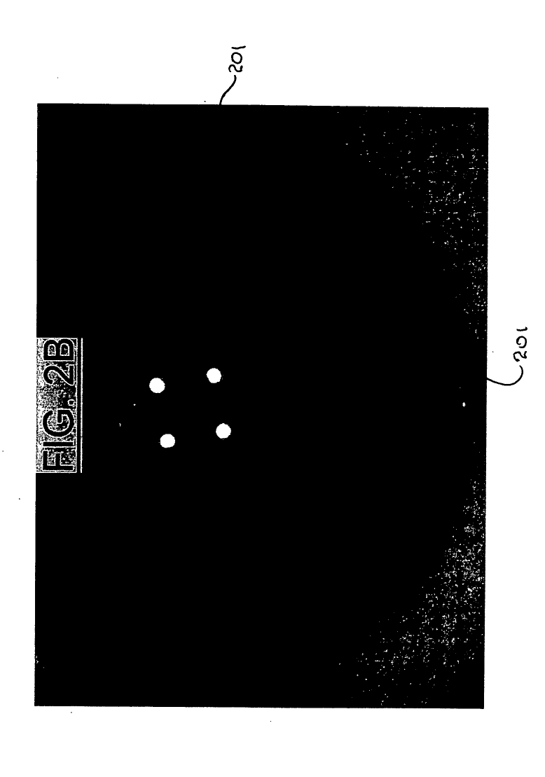

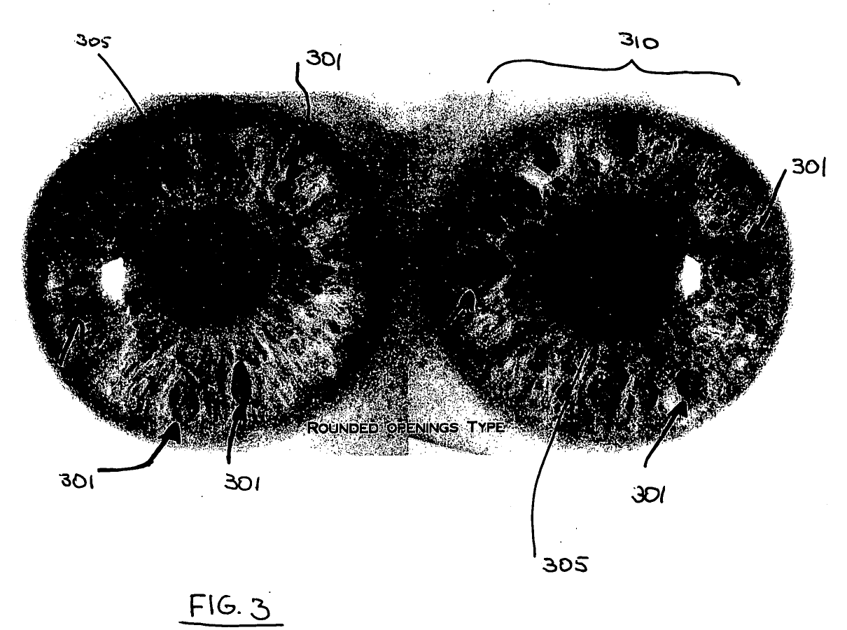

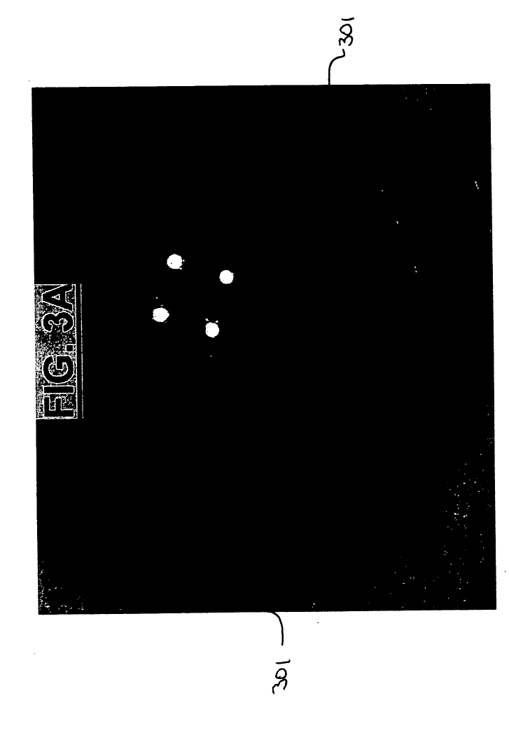

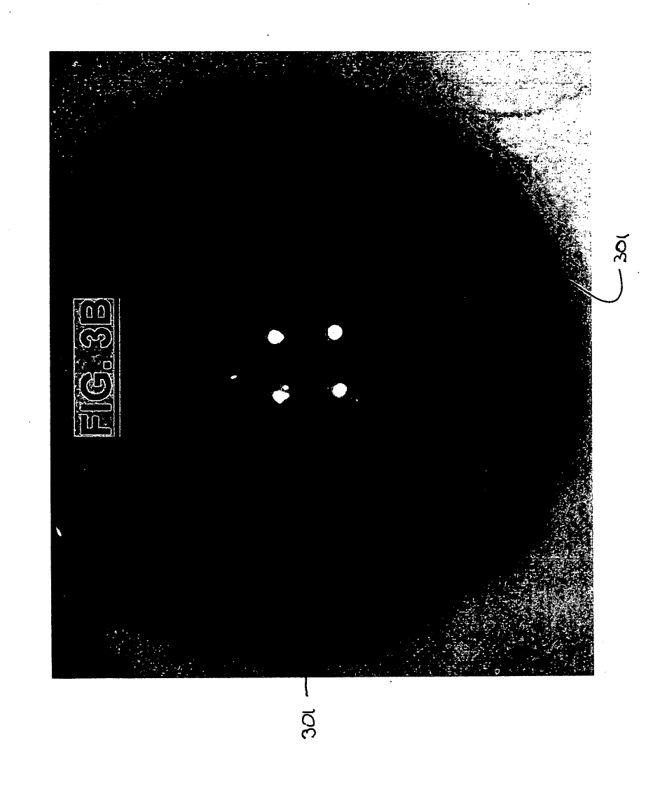

The invention includes, but is not limited to, iris marker categorizations such as an accumulation of color in the iris, know as “Psora”, e.g., a brown to a golden dot-like shape of pigmentation termed “dotted pigmentation.” This marker 201 is illustrated in FIGS. 2, 2A and 2B along with the pupil 305 within the iris 310. Another structure that may be used in the practice of the invention is observed “rounded openings” within the fibrous structure of the iris, also known as “Lacunae”. This marker 301 is illustrated in FIGS. 3 3A and 3B with the pupil 305 contained within the iris 310.

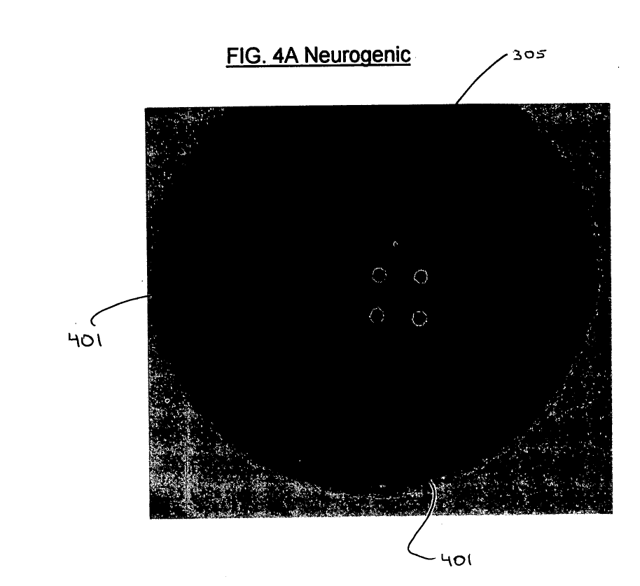

An additional marker is termed “Neurogenic” and is illustrated in FIGS. 4A and 4B. This structure is comprised of fibers 401 radiating from the pupil 305 in substantially parallel patterns. It will be appreciated that the relative proximity or density of the fibers can be correlated to a thinking, controlling or constricted behavior in contrast to a more open orientation of more emotional, open or agreeable behavior.

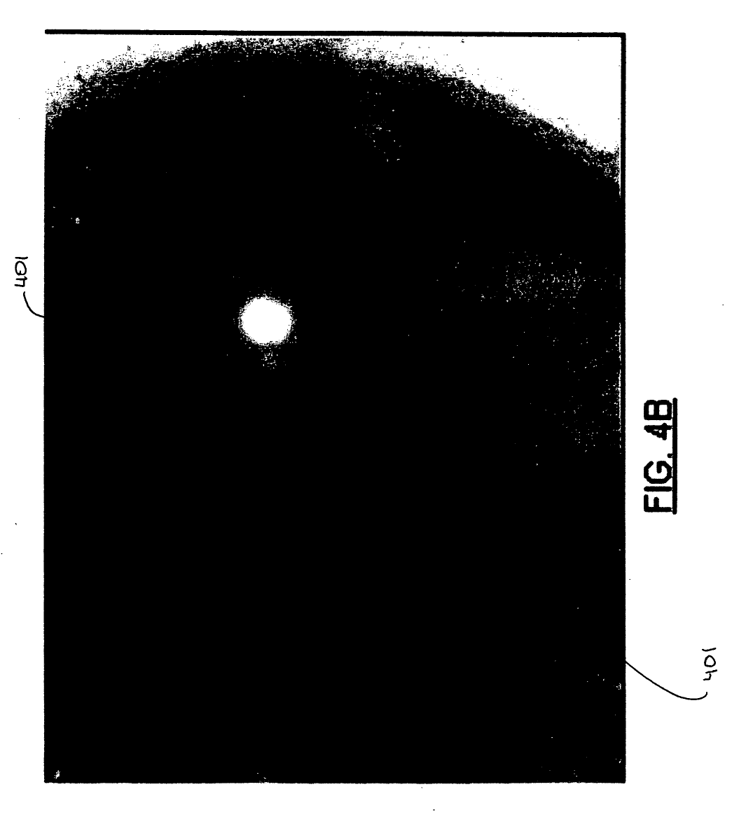

A “Combination” iris marker, also referred to as Mixed or Combination Type, is illustrated in FIGS. 5A and 5B. This marker has the presence of dotted pigmentation 201 and rounded openings 301 in the same iris 310.

In one embodiment of the invention, Lacunae and Psora may be considered as “primary structures.” Observed Neurogenic or Combination structures may be considered “secondary”. It will be appreciated that there can be multiple permutations of the structures observed in an iris. In another embodiment of the invention, the three structures termed Psora (dotted pigmentation), Lacunae (rounded openings) and Neurogenic are considered primary structures. In a third embodiment, Psora, Lacuanae, Neurogenic and Combination markers are primary structures. In other embodiments, Iris color is not considered a structural component as color variations can change over time.

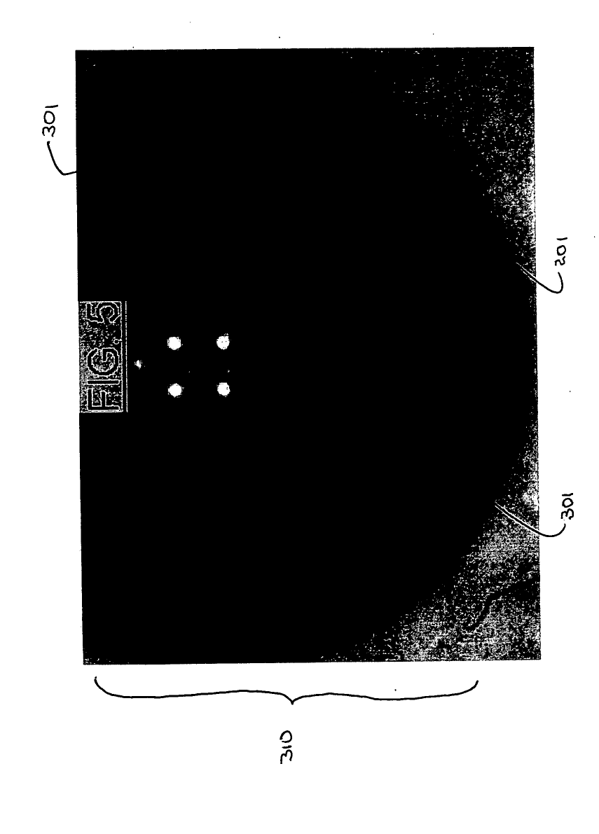

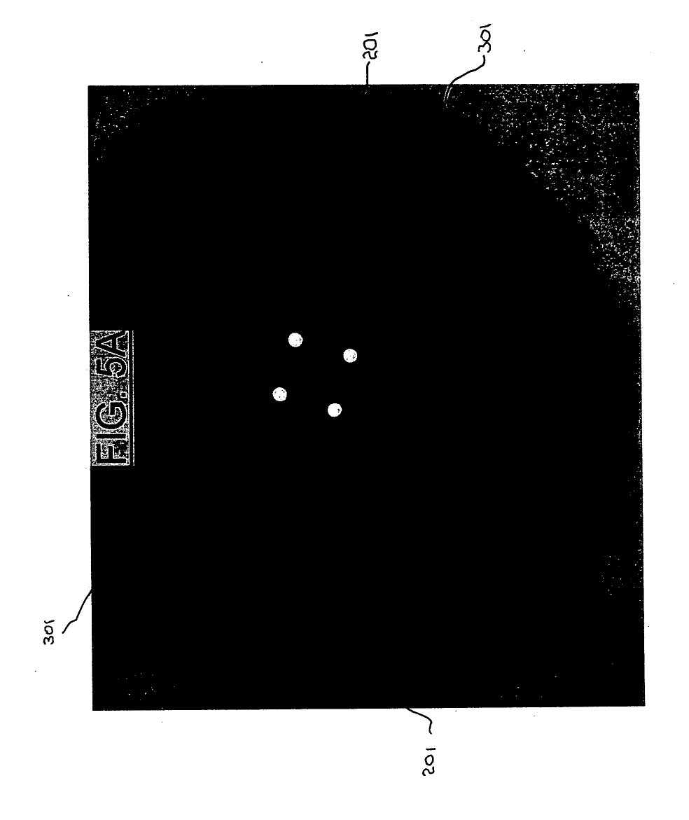

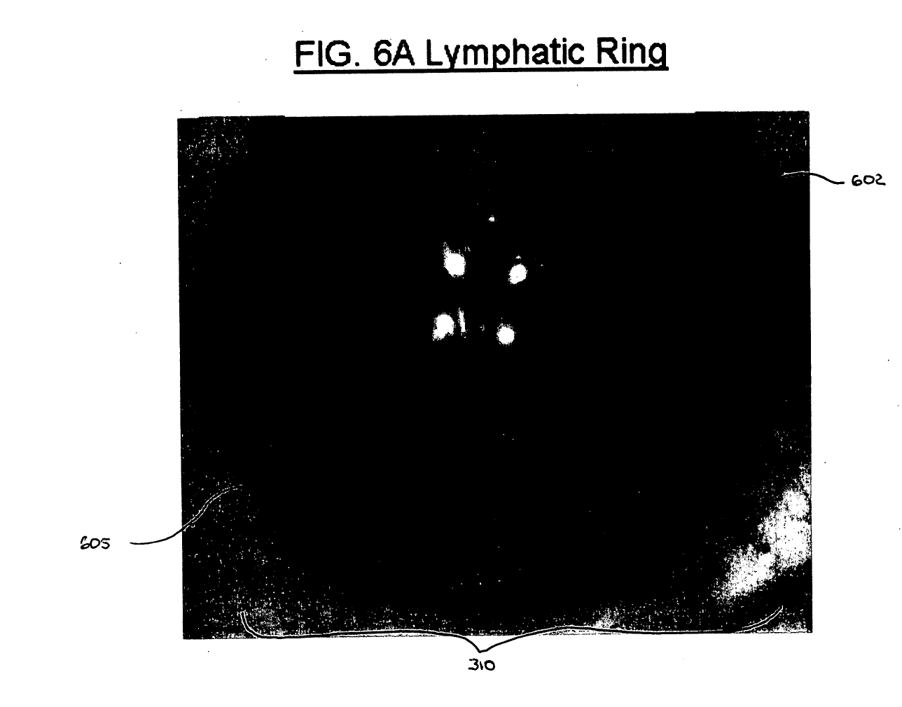

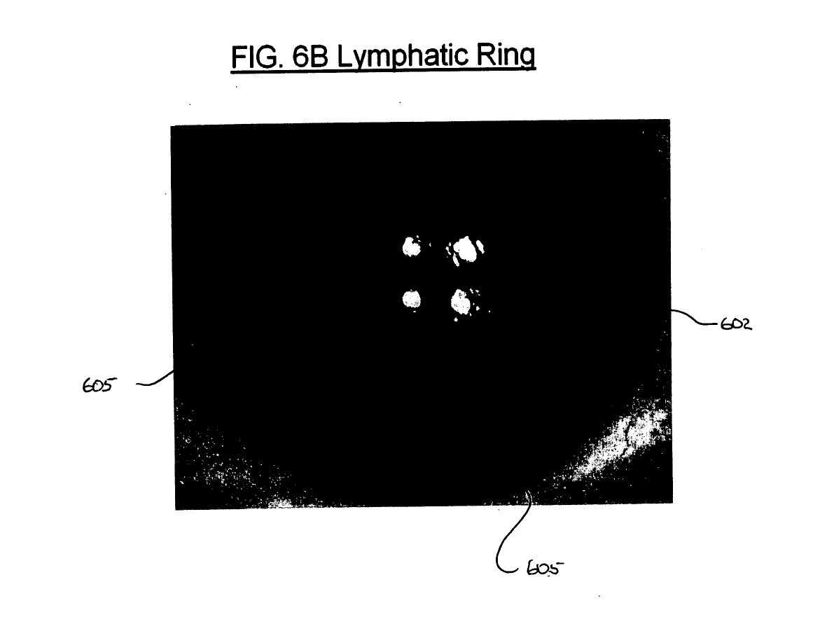

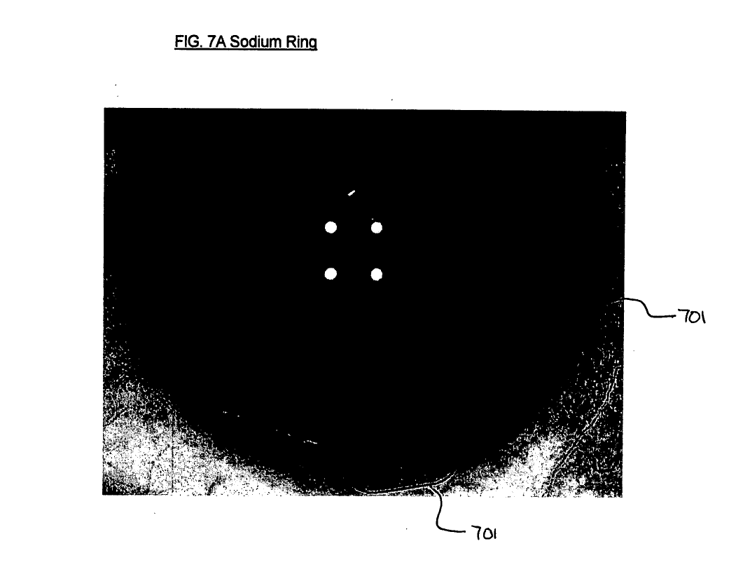

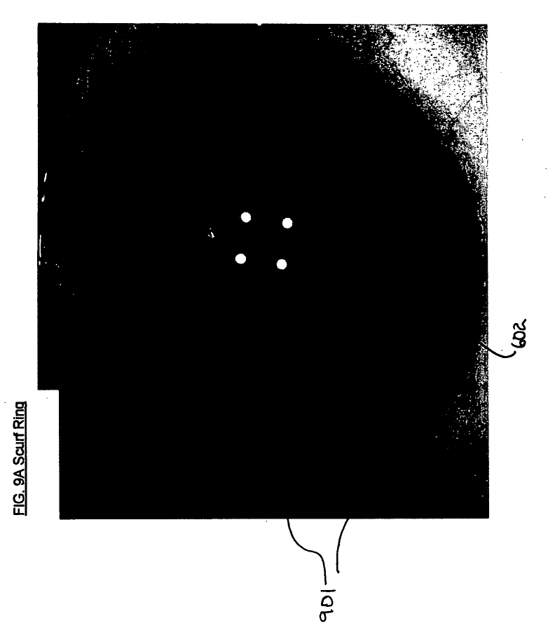

Other structures or shapes considered and categorized as iris markers may include variations within the iris. These variations often appear as bands or rings (hereinafter “rings”) encircling the pupil. FIGS. 6A and 6B illustrates a secondary structure, termed “Lymphatic ring”, about the periphery 602 (outer most zone or the perimeter) of the iris 310. This ring may appear as groups of differing colored groups 605 in a circular pattern in the periphery, similar to a strand of pearls. FIGS. 9A and 9B illustrate ring pigmentation structure is sometimes observed as a dark blue band 901 around the periphery of the iris. This marker may be termed “Scurf Rim” or “Scurf Ring”. Another variation, illustrated in FIGS. 7A and 7B, is a white or whitish-yellowish variation 701 about the periphery 602 and can be termed the “Sodium Ring”. The variation may be observed with the rounded opening or Neurogenic, or dotted pigmentation structures.

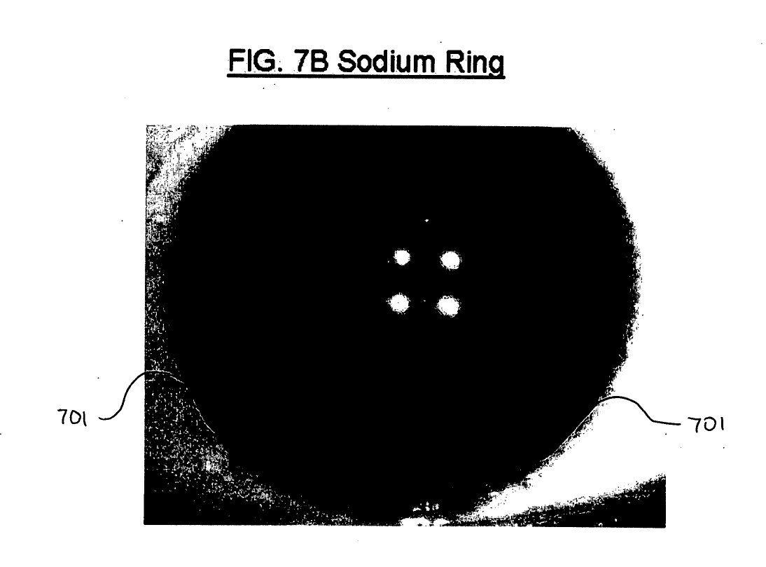

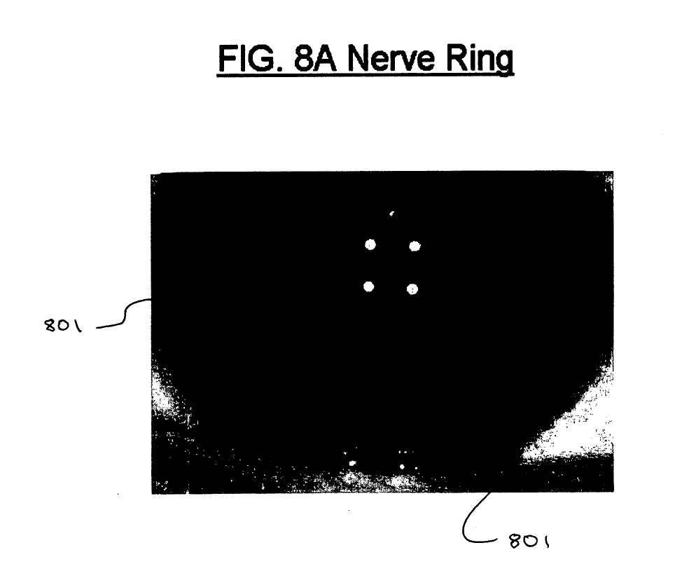

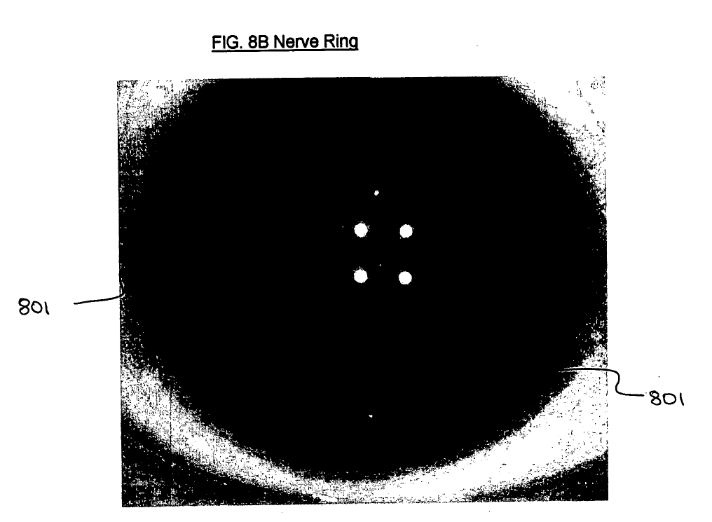

FIGS. 8A and 8B illustrate yet another iris structure categorized in embodiments of the invention. This structure is a ring 801 having a radius generally one-half or more away from the center of the pupil 305 and may be termed “Nerve Ring”.

Various chart or map systems are known in the art and have been used for a variety of purposes, such as analyzing physical and mental health or function. A notable characteristic of several of the prior art charts (FIGS. 1A and 1C) is the distinct separation between the different areas of the iris.

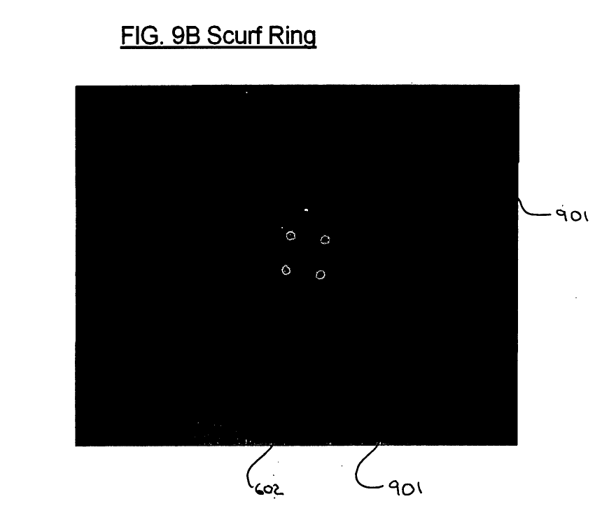

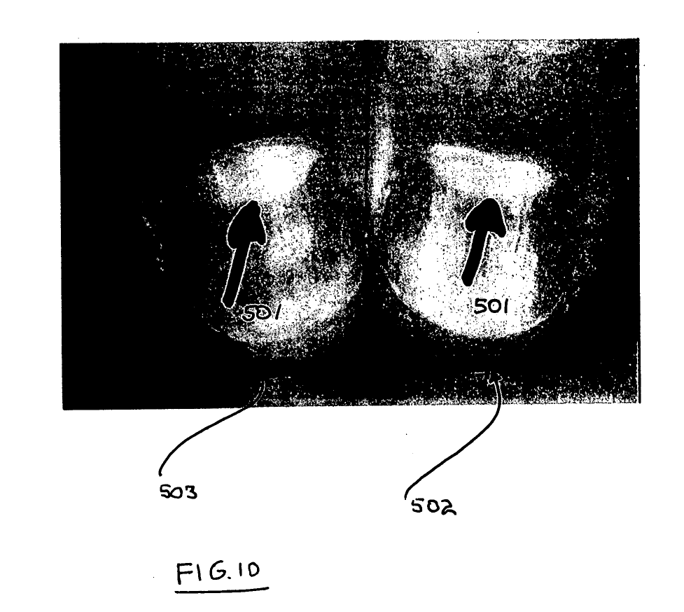

In practicing the invention, markers can be observed in terms of one or more differing structures or of similar structures having differing shapes. (Differing “shapes” are variations in relative size or form of otherwise similar structures). The identification and categorization of markers (sometimes termed “charting” or “mapping”) can include size, shape, number and positions and can have both additive or diminishing roles, e.g., “plus and minus”. FIG. 10 illustrates the half moons 501 in the thumbs as an example of other individual physical characteristics or “bio-markers” that can be used in combination with the invention. These “half moon” structures can be compared or assessed with the left and right thumb 502 503 placed together as illustrated. Other bio-markers utilized in combination with the invention are the individual's height and weight, shape of the face or facial symmetry, shoulder width, diameter of one or both wrists or ankles, eyelid droop, birth order sequence or “yin or yang” body type. The invention can be used and verified in combination with the bio-markers or other categorizes such as blood type and DNA.

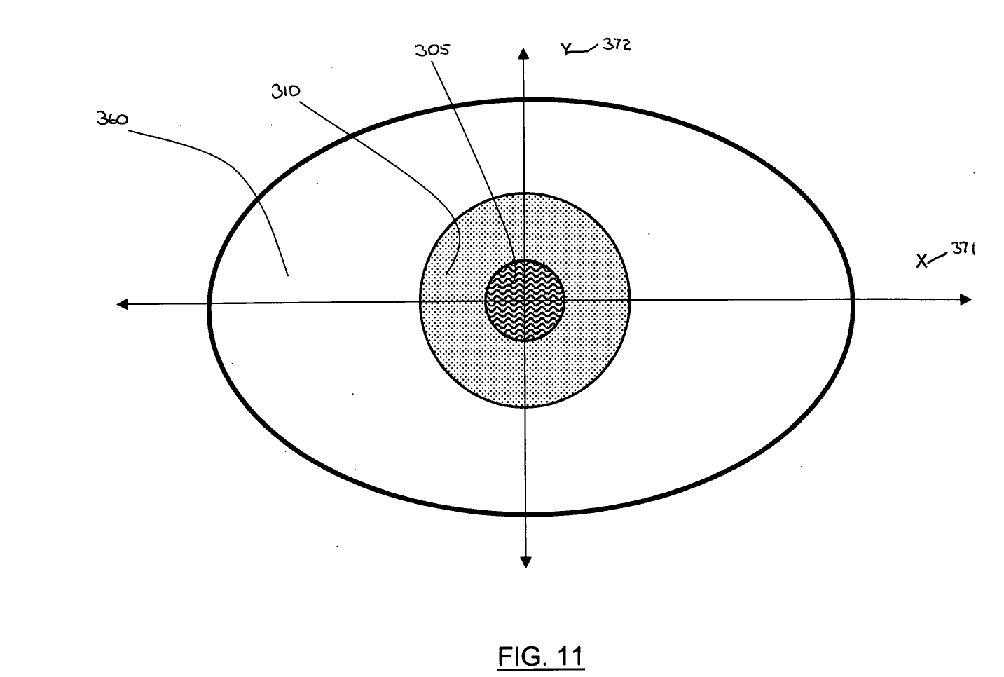

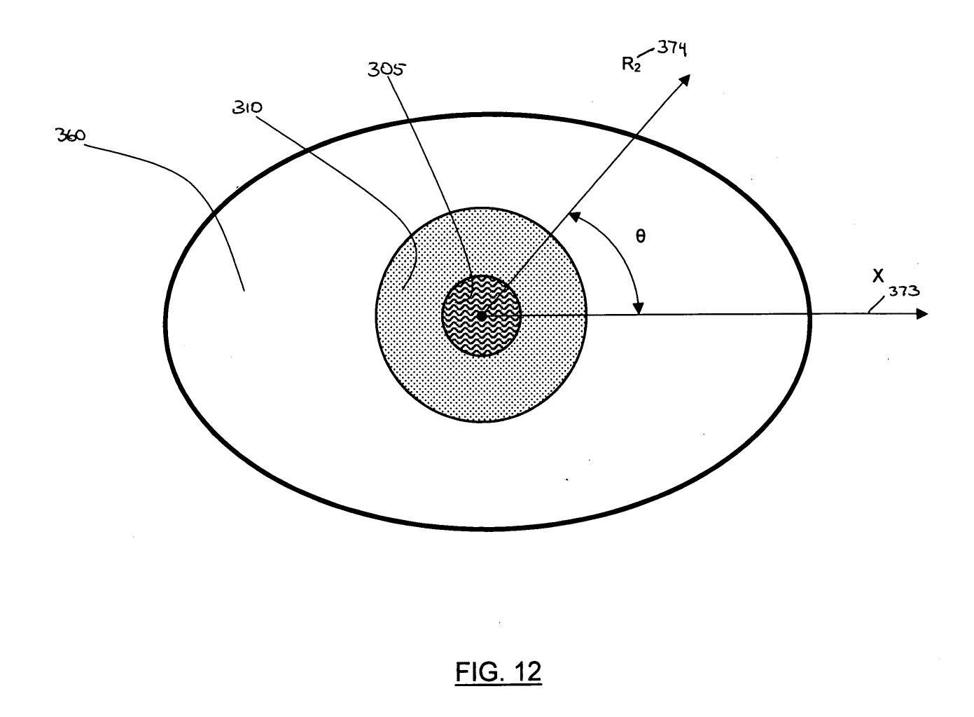

FIG. 11 illustrates a simple quadrant map of an eye, containing the pupil 305, iris 310 and the remaining visible portion 360 of the eye. Markers can be mapped or entered into the database of information (“data collection” or “information”) by their location utilizing X-Y or Cartesian coordinates 371 372. FIG. 12 illustrates a simple polar coordinate map of an eye. In this mapping system, the marker can be defined by its position relative to the distance from the center position on a radial vector R₂ 374 and the angle θ of the vector to a reference line 373. In the example shown in FIG. 12, the center is shown as the center of the pupil 305 surrounded by the iris 310 and the remaining 360 visible portion of the eye. Using either of these commonly known methods, or an alternate coordinate method, the information can accurately record the size and position of each marker. This information can be categorized by the type of marker and is size and relation to other markers. A map and information can be recorded for the iris of each eye. Reference to FIG. 1B indicates the significance of position for detected markers as used in the preferred embodiment of the invention. The position and size may be utilized in evaluation of the information, including use in one or more algorithms.

In one application of iridology as may be utilized by the present invention, the dotted pigmentation and rounded openings are “opposites” or “counter-veiling”. In an elementary example, the presence of rounded openings (or “Lacunae”) in a position AB (representing specific X-Y Cartesian coordinates) in one individual may be expected to be compatible to a second individual having dotted pigmentation (or “Psora”) in the AB position.

In one embodiment, an individual dotted pigmentation structure may be assessed or given differing evaluative significance in contrast an occurrence of an individual rounded opening. In another embodiment, the presence of multiple large rounded openings, each having a relative consistent, albeit, differing radii of circumference, or with thick fibers at the edges, may be given lesser evaluative significance in contrast to the presence of smaller “elliptical” or “ovule” shapes. Similarly, the dotted pigmentation structures may differs by color, shape, and size. A structure that is relatively dark but with less defined periphery, for example, may in be evaluated differently than a dot that is well defined. In the preferred embodiment of the invention, presence of significant dotted pigmentation structures in the iris of one individual can indicate likely compatibility with an individual observed to have occurrences of rounded opening iris pigmentation structure.

As indicated in the preceding paragraph, an embodiment of the invention also teaches assessing or predicting, i.e., “evaluating” the social compatibility or romantic attraction between or among individuals. The invention can include introducing or matching individuals evaluated to have likely compatibility. This embodiment can be utilized alone, or in conjunction with other techniques such as written questionnaires, videos, social gatherings, etc.

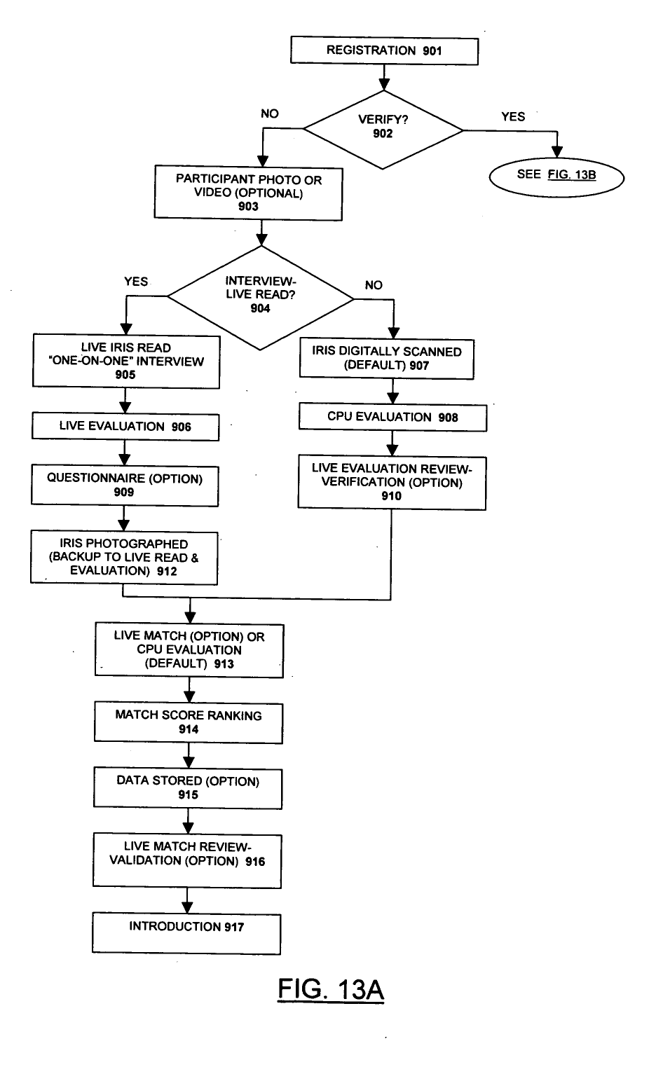

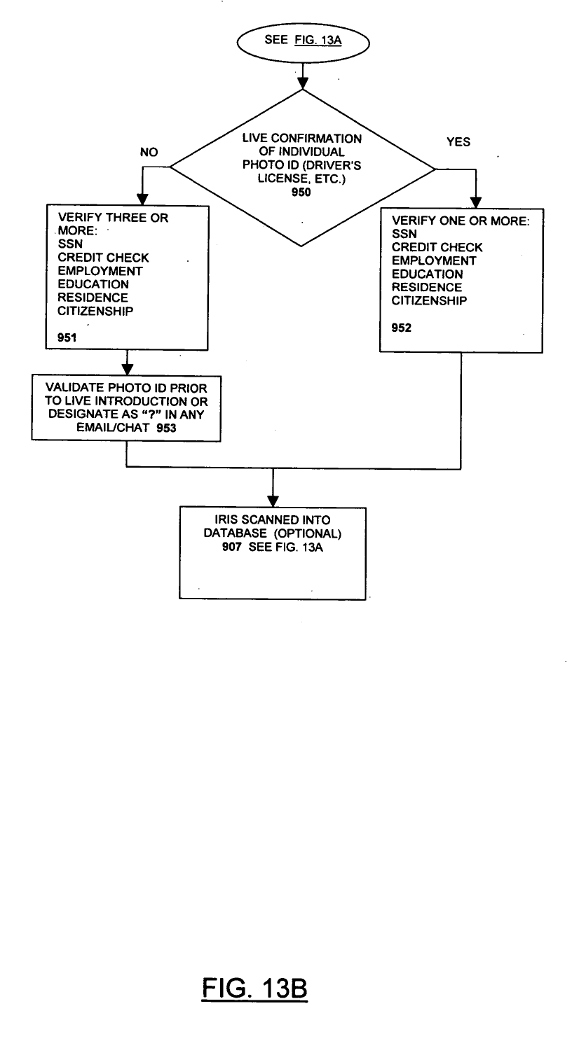

FIG. 13A illustrates one embodiment that may comprise one or more of the following the steps. It will be appreciated that all or some of these steps may be taken at differing times and locations. Also the order that these steps are performed may vary. As indicated, all steps are not required. The process may begin with individual registration 901, which may include address, telephone number, drivers' license registration information being recorded and optionally verified 902. (A possible verification process is illustrated in FIG. 13B.) The participant may submit (or have taken) optional facial photos or video 903. The participant may have the iris markers “read” or recorded by an examiner, in either a live setting or via electronic (including but limited to web cam, scanned photo, digital photo, or digital imageless data input) means 904 905 (referred variously as “iris scan”, “iris photograph”, or “digital scanning”. An evaluation 906 can be made by a person, either the person reading or recording the markers or by a separate person using the recorded information. The evaluation can be optionally supplemented with the participant's responses to questions or questionnaire 909. These responses can be indicate or specify personal preferences (hobbies, interests, etc.) and interpersonal preferences (features of desired individual). The evaluation can be optionally supplemented with a recorded image, e.g. photo of the iris.

As an alternate method, the iris markers can be machine read 907 by a scan of a photo, or by scanning (imageless digital data input) the actual iris, thereby omitting a separate photo or recorded imaging step. The evaluation is made by a CPU utilizing one or more algorithms. It will be appreciated that this alternate method may be implemented in very rapid fashion and at relative low cost. The results can optionally be submitted for review or verification by an examiner 910. The algorithm may categorize the participant and provide data, such as contact information, of selected other participant(s). The selected participants may be chosen by the algorithm determination of possible compatible individual utilizing the iris database created by the invention. In this embodiment, there is little, if any, intervention or monitoring by a third party other than creation the algorithm and database and may be termed “self-selection”.

The iris marker information may be optionally transferred to a database (not shown) that also contains all or some of the data collected during preceding steps. The database may also be supplemented with information supplied from other sources and at a differing time (not shown). The supplemental information may include, but not be limited to information performed as part of a background check or verification of the participant's identity as shown in FIG. 13B and discussed below. It may also include later income, occupation or marital data, thereby allowing “fine-tuning” or modification of the algorithm(s).

The evaluation of the individual can be “matched” 913 with the evaluation or other information of one or more separate individuals. This matching can be machine performed, i.e., a CPU utilizing algorithms or by trained personnel. The results can be ranked 914 and optionally stored 915. There can also be a validation or review step of the match rankings 916. The individual participant can then be introduced 917 to one or more other individuals.

FIG. 13B illustrates optional steps in background checking preferably used prior to the introduction of individuals illustrated in FIG. 13A. For example, it may be beneficial to confirm that no participant is listed as a “registered sex offender”. The verification can be performed by staff verifying a driver's license 950 with one of several other sources such as Social Security Numbers, credit reporting agencies, employment, etc., 952. If the background checking is performed using electronic media accessing separate stored electronic databases, it may be desired that a larger set of data be affirmatively verified, e.g., the individual's identity validated by three or more sources 951. There may be a mechanism for protecting the confidentiality of all or some of the data, such as a firewall when information or evaluations are shared as part of a matching step.

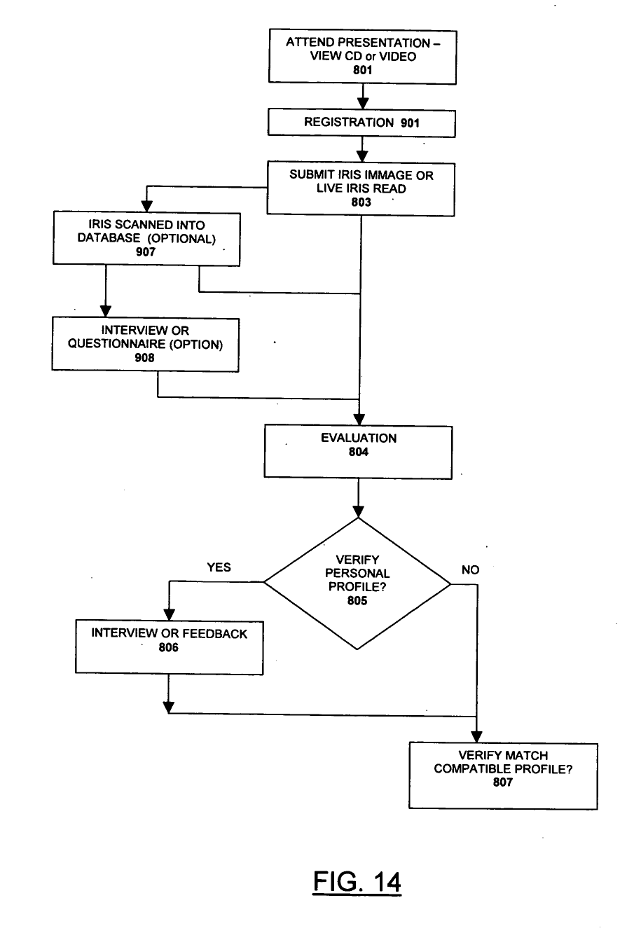

FIG. 14 illustrates another embodiment of the practice of the invention. The process commences with participants attending an educational or informational presentation, individually or with others, reviewing informational materials such as CDs, DVDs, books and charts, or video tapes 801. The participant(s) registers 901 and can either submit an iris image or have a “one on one” reading of their iris markers 803. The one on one reading can be “live” or via electronic media such as a “web cam”. The information can be recorded and added to a database 907 followed by an optional interview or submission of a questionnaire or other feedback/information submission 908. Utilizing all or some of the collected information an evaluation of the individual is made 804. A verification of the personal profile, utilizing the evaluation and other sources can optionally conducted 805. This can then be followed by an informational or feedback step 806 or directly to matching with one or more compatible or otherwise selected individuals 807 using the database or “self-selection”.

It will also be appreciated that steps similar to those illustrated in FIGS. 13A, 13B and 14 may be used in employment or other selection modes.

In the preferred embodiment, the invention includes the steps of education, registration, evaluation and introduction. The education component of the invention can be practiced by in conjunction with direct marketing of the service. Information videos, print ads and radio announcement may provide initial information of the service and time/location where additional information can be obtained. An example may be through instruction lectures will be held at local hotels. These education events may be limited to a maximum of 2 hours. The science of iridology can be explained. The technology used and the methodology, including privacy and safety policies can also be explained. One or several attendees may volunteer or permit their eyes to be digitally photographed and interpreted for mate relations within the course of the evening. Registration, including iris photographing or scanning (capturing the image digitally or direct imageless electronic input) may be initiated at the information lecture. Also, one-on-one interviews may be scheduled. Registration packages, perhaps including the cameras, may be distributed. In yet another embodiment, a package may be mailed to an interested potential participant/client. In an, a CD or other embodiment, a potential participant may be given access to a website where information may be obtained. This may be part of a pre registration step.

The registration component may be conducted through responses received from package mail outs included within the education component or separately. For example, an information package containing a CD, DVD or videotape may also contain registration information such as consent forms, questionnaires and identification data. The data may be subject to verification when received by the service provider.

The package may also disposable or recyclable camera with attachments to facilitate the individually comfortably and accurately taking a picture of one or both iris'. The package could be returned to the service provider for the completion of registration image scanning and evaluation. A further embodiment would permit the participant to purchase the evaluation product without further services or as an optional add on product. The participant may also be given the opportunity to review the evaluation or the evaluation as combined with questionnaire responses or verified data. The participant could also be given the option to participate in a one-on-one interview as a supplementation to or validation of the evaluation process.

The invention may be practiced with financial incentives for participants to enroll others into service. This may utilize one of the several methods known in the home shopping industry. In yet another embodiment, the some of the registration steps may be taken at a mall kiosk. In still another embodiment, the individual's iris may be scanned from data collected at the individuals' web camera or by a digital camera and image transmitted to a location for evaluation via the Internet.

Modes of introduction may be varied based upon several factors, such as the service options selected by the participant, the individual evaluation, or otherwise. One method could be via the Internet utilizing email or monitored chat rooms. In the self-selection embodiment, the registration steps could include the participants consenting to disclosure of their email address without further monitoring or intervention of the service provider. Another methodology would be individualized matchmaking wherein the service provider selects one or more persons evaluated to be likely compatible with the participant customer. Interactive social hours or events may also be sponsored and hosted for participants. Based upon the evaluations, each participant may be given a distinctive badge/nametag and perhaps along with their iris pictures and name. Professionally trained group facilitators will first lead the entire group in fun interactive experiences as a means to meeting each other in a safe non threatening environment. In one simple variation, the participants will be next put into 2 separate rooms one containing those males with one distinct badge/nametags and females with selected badge/nametags. The opposite combination will be in the other room. Again real time experiences will guide those singles to meet for potential mate relations. The events may be of several hours or perhaps for several days. These events may be held on local, regional and national as well as international levels.

In another variation of the introduction component may provide an introductory setting for groups of individuals selected from the database that are predicted to have compatible behaviors. For example, the individuals may all be selected from a group that is believe to enjoy problem solving, the games of chess, bridge, etc., all without ever having been asked (and thereby eliminating a participant's tendency to answer a question the way they believe they should or without having been asked obtuse hypothetical questions.) It will be appreciated that the selection process may be supplemented with information collected from known techniques, e.g., questionnaires or interviews.

In another embodiment, the personal introduction may be made through one-on-one pairing. The level of control or structure, if any, can be varied in any manner. For some predicted personality types, there may be no “introduction” other than individuals within the selected group being sent to a large populated shopping mall with modest clues or discretionary identifiers of the other participants, thereby fostering spontaneity and intrigue. For example, a woman may be told go to the mall and look for a man/men carrying two shopping large shopping from one or more separate stores located in the mall. The “shopping bag men” may or may not know of the others, nor of any characteristics of the women.

For individuals evaluated to be of other personality types, other and presumably more suitable introductory techniques may be arranged.

This specification is to be construed as illustrative only and is for the purpose of teaching those skilled in the art the manner of carrying out the invention. It is to be understood that the forms of the invention herein shown and describe are to be taken as the presently preferred embodiments. Various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention. While specific embodiments of structure categorization and description have been illustrated and described, numerous modifications are possible without departing from the spirit of the invention. Further modifications and alternative embodiments of this invention will be apparent to those skilled in the art in view of this specification.

1. A data collection comprising at least one individual's identification and identified iris marker that is in a machine-readable format.

2. The data collection of claim 1 further comprising the interpersonal preferences of at least one of the individuals.

3. The data collection of claim 1 further comprising information selected from a group consisting of age, gender, driver's license number social security number, telephone numbers, email addresses, residence address, mailing address, employment status, employer identification, occupation, education level, socio-economic status, annual income, bio-markers, medical information, birth order, the number and age and gender of children, current and past marital status, personality characteristics, photo, and interpersonal preferences.

4. A method of introducing an individual to at least one other individual utilizing the iris markers of at least one individual comprising using at least some information that is in machine readable format.

5. The method of claim 4 further comprising using interpersonal preferences of at least one individual.

6. The method of claim 4 further comprising using images of iris markers that are in machine readable format.

7. The method of claim 6 further comprising using an algorithm.

8. The method of claim 4 further comprising information selected from a group consisting of age, gender, driver's license number social security number, telephone numbers, email addresses, residence address, mailing address, employment status, employer identification, occupation, education level, socioeconomic status, annual income, bio-markers, medical information, birth order, astrological information, the number and age and gender of children, current and past marital status, personality characteristics photo, and personal and interpersonal preferences.

9. The method of claim 8 further comprising using at least some information that is in machine readable format.

10. The method of claim 9 further comprising using images of iris markers that are in machine readable format.

11. The method of claim 10 further comprising using an algorithm.

12. The method of claim 8 further comprising using an algorithm to evaluate the iris marker's of an individual.

13. The method of claim 12 further comprising comparing the evaluation of iris markers to information of at least one individual.

14. A method of evaluating an individual using observed iris markers of at least one iris to predict elements of behavior comprising the steps of:
a. observing an iris of an individual; and
b. using at least a portion of the information observed to predict behavior of the individual.

15. The method of claim 14 further comprising the predicting the behavior of the individual to at least one other individual.

16. The method of claim 14 further comprising using the evaluation to select at least one second individual for introduction for possible romantic relationship.

17. The method of claim 14 further comprising using the evaluation to select at least one second individual for social compatibility.

18. The method of claim 14 further comprising using the evaluation as part of an employment selection process.

19. The method of claim 14 further comprising recording at least some of the information observed in a machine readable format.

20. A method of creating a personal evaluation using identified iris markers of an individual comprising the steps of:
a. assigning an identifier to an individual
b. observing an iris of at least one eye of the individual;
c. recording information pertaining to the size, location and number of at least one iris marker within the observed iris;
d. evaluating the person based upon the recorded information;
e. correlating the evaluation and identifier; and
f. using the evaluation as an indicator of possible preferences and characteristics of the individual.

21. The method of evaluation of claim 20 further comprising including at least one other information selected from a group consisting of age, gender, driver's license number social security number, telephone numbers, email addresses, residence address, mailing address, employment status, employer identification, occupation, education level, socioeconomic status, annual income, bio-markers, medical information, birth order, astrological information, the number and age and gender of children, current and past marital status, personality characteristics, photo, and personal and interpersonal preferences.

22. The method of claim 20 wherein the evaluation is compared to a plurality of similarly created evaluations of other individuals as an indicator of possible common preferences and characteristics.

23. The method of claim 20 wherein the evaluation is compared to a similarly created evaluation of at least one second individual for possible romantic relationship.

24. The method of claim 20 wherein the participant selects the one or more other participants for introduction directly from information provided from a database.

25. The method of claim 20 wherein the evaluation uses an image of an iris.

26. The method of claim 20 wherein the evaluation is computer assisted.

27. The method of claim 24 wherein the evaluation includes using an image in machine readable format.

28. The method of claim 25 further comprising using a digital image.

29. The method of claim 20 further comprising digital inputting of information.

30. A data collection in a machine readable format comprising at least one individual's identification and iris markers comprising one or more of rounded openings, dotted pigmentation, parallel fibers and combination.

31. The data collection of claim 30 further comprising the location and numerical relationship between among the markers.

32. A method of creating a personal evaluation using iris markers of a person comprising the steps of:
a. counting rounded openings and assigning a location and value for at least one of the size or shape of each counted opening and the width of surrounding fiber;
b. counting dotted pigmentation and assigning a location and a value for at least one of the dotted pigmentation size, shape, color and boundary;
c. counting parallel fibers that are oriented in a substantially radial direction from the pupil and assigning a location and value for at least the proximity of fibers to the pupil, proximity of the fibers to each other, the edge of the iris, location of substantial deviations in the parallel fibers and location of significant absence of parallel fibers;
d. assigning a value to at least one of the factors of distance between the pupil and iris periphery, iris symmetry, symmetry of autonomic nerve wreath, distance from pupil, and location of any breaks in the ring;
e. assigning a value to at least one of the factors of color of the iris, variations in color or color intensity, existence of color concentration around boundary with the pupil or the autonomic nerve wreath;
f. assigning a value to at least one of the factors of an existence of color rings, variations in ring colors, and number of autonomic nerve wreath; and
g. assigning a value to at least one of the factors of numerical relationship between the number of rounded openings and pigmented dots, numerical relationship of rounded openings to average distance of parallel fibers, and numerical relationship of the number of dots to the average distance of parallel fibers; the number of rounded openings and pigment dots located between the autonomic nerve wreath and pupil, and whether an iris of one eye has more pigmentation dots and rounded openings that the other eye.

33. The method of claim 32 further comprising using the at least one of the assigned values to predict behavior.

34. The method of claim 32 further comprising recording at least one of the variations.

35. The method of claim 32 further comprising recording at least one of the counted elements.

36. The method of claim 32 further comprising recording at least one of the assigned values.

37. The method of claim 32 further comprising assigning an identifier to each individual and the individual's persons evaluation.

38. The method of claim 33 wherein the predicted behavior is compared to actual behavior.

39. The method of claim 38 wherein the actual behavior occurred prior to the evaluation.

40. The method of claim 38 wherein the actual behavior occurred after the evaluation.

41. The method of claim 38 further comprising evaluating a difference in actual and predicted behavior.

42. The method of claim 39 further comprising evaluating the difference and the observed iris markers.

43. The method of claim 39 further comprising evaluating the difference and at least one of the assigned values.

44. The method of claim 37 further comprising comparing the evaluation with personal preferences.

45. The method of claim 37 further comprising comparing the evaluation with interpersonal preferences.

46. A method of predicting behavior of an individual including the steps of
a. evaluating at least one factor selected from a group consisting of counted rounded openings, location of rounded openings, an assigned value for the size of the rounded opening, an assigned value for the shape of the rounded opening, an assigned value for the width of surrounding fiber to the rounded openings, counted dotted pigmentation, location of dotted pigmentation, an assigned value for doffed pigmentation size, assigned value for dotted pigmentation shape, assigned value for dotted pigmentation color, assigned value for dotted pigmentation boundary, counted parallel fibers oriented in a substantially radial direction from the pupil, an assigned location for proximity of parallel fibers to the pupil, an assigned value for the proximity of parallel fibers to the pupil, the edge of the iris, location of substantial deviations in the parallel fibers and location of significant absence of parallel fibers;
b. assigning a value to at least one of the factors of distance between the pupil and iris periphery, iris symmetry, symmetry of autonomic nerve wreath, distance from pupil, and location of any breaks in the ring;
c. assigning a value to at least one of the factors of color of the iris, variations in color or color intensity, existence of color concentration around boundary with the pupil or the autonomic nerve wreath;
d. assigning a value to at least one of the factors of an existence of color rings, variations in ring colors, and number of autonomic nerve wreath; and
e. assigning a value to at least one of the factors of numerical relationship between the number of rounded openings and pigmented dots, numerical relationship of rounded openings to average distance of parallel fibers, and numerical relationship of the number of dots to the average distance of parallel fibers; the number of rounded openings and pigment dots located between the autonomic nerve wreath and pupil, and whether an iris of one eye has more pigmentation dotes and rounded openings that the other eye counted rounded openings, dotted pigmentation, parallel fibers, distance between the pupil and iris periphery, iris symmetry, symmetry of autonomic nerve wreath, distance from pupil and break in the wreath, iris color, variations of iris color intensity, color concentration around the boundary and the autonomic nerve wreath, color rings, variations in color ring number of autonomic nerve wreath and in the iris.

47. The method of claim 46 further comprising recording all or part of the evaluation, assessment and assigned values in machine readable format.
